(19) United States
(12) Patent Application Publication
(10) Pub. No.: US 2008/0124259 A1
(43) Pub. Date: May 29, 2008

(54) Metal Extraction

(76) Inventors: Eric Girvan Roche, New South Wales (AU); John Andrew Lawson, New South Wales (AU); Alan David Stuart, New South Wales (AU)

Correspondence Address: BRINKS HOFER GILSON & LIONE, P.O. BOX 10395, CHICAGO, IL, 60610, US

(21) Appl. No.: 11/868,689

(22) Filed: Oct. 8, 2007

Related U.S. Application Data
(63) Continuation of application No. PCT/AU2006/000470, filed on Oct. 12, 2006.

(30) Foreign Application Priority Data
Apr. 7, 2005 (AU) 2005901748

(51) Int. Cl. C01G 23/08

(52) U.S. Cl. 423/82

(57) ABSTRACT

A sulfate process for producing titania from a titaniferous material as disclosed. The process is characterized by a particular leach step for leaching titaniferous material.

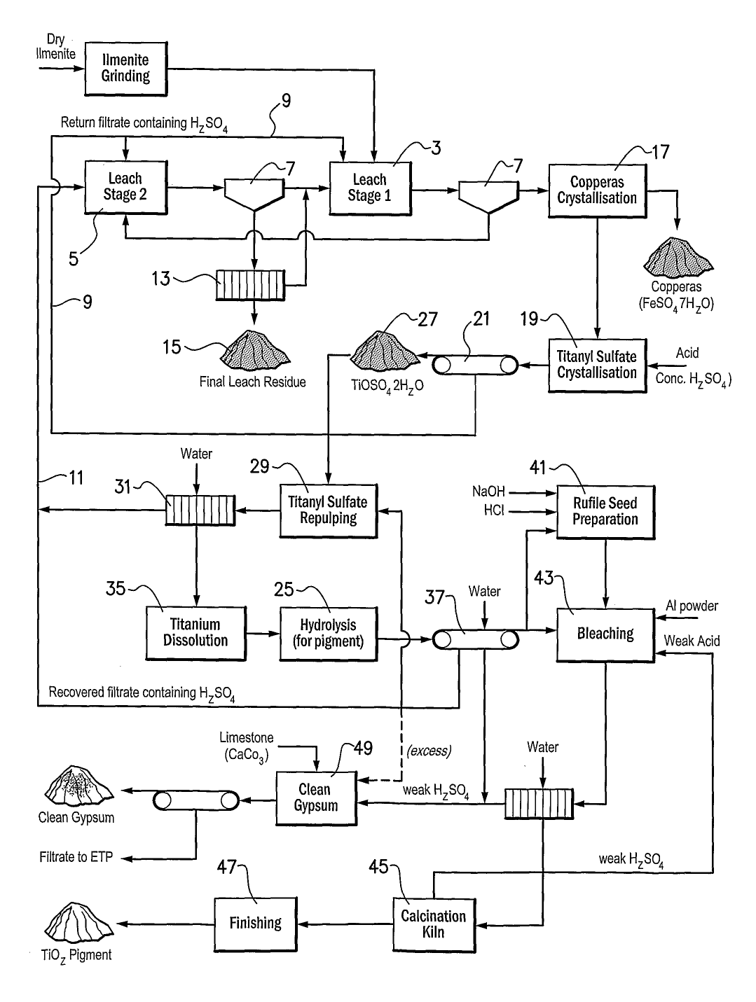

This application is a continuation of and claims priority from PCT/AU 2006/000470 published in English on Oct. 12, 2006 as WO 2006/105613, and from AU 2005/901748 filed Apr. 7, 2005, the entire contents of each are incorporated herein by reference.

### FIELD OF THE INVENTION

The present invention relates to a process for producing titania from a titaniferous material.

The term “titaniferous” material is understood herein to mean any titanium-containing material, including by way of example ores, ore concentrates, and titaniferous slags.

The present invention relates particularly to the sulfate process for producing titania from titaniferous material.

International application PCT/AU2004/001421 in the name of the applicant describes an invention of a sulfate process made by the applicant. The disclosure in the International application is incorporated herein by cross-reference.

In general terms, the present invention provides a sulfate process for producing titania from a titaniferous material (such as ilmenite) of the type which includes the steps of:

(a) leaching the solid titaniferous material with a leach solution containing sulfuric acid and forming a process solution that includes an acidic solution of titanyl sulfate (TiOSO₄) and iron sulfate (FeSO₄);

(b) separating the process solution and a residual solid phase from the leach step (a);

(c) precipitating titanyl sulfate from the process solution from step (b);

(d) separating the precipitated titanyl sulfate from the process solution;

(e) treating the precipitated titanyl sulfate and producing a solution containing titanyl sulfate;

(f) hydrolysing the titanyl sulfate in the solution and forming a solid phase containing hydrated titanium oxides and a liquid phase;

(g) separating the solid phase containing hydrated titanium oxides and the liquid phase;

(h) calcining the solid phase from step (g) and forming titania; and

(i) removing iron sulfate from the process solution from step (b) and/or the depleted process solution from step (d).

The term “hydrated titanium oxides” is understood herein to include, by way of example, compounds that have the formula TiO₂.2H₂O and TiO₂.H₂O.

In addition, the term “hydrated titanium oxides” is understood herein to include compounds that are described in technical literature as titanium hydroxide (Ti(OH)₄).

It is also noted at this point that acid concentrations mentioned hereinafter are understood herein as being determined by titration of an oxalate buffered solution sample with sodium hydroxide solution to an end point of pH 7.

It is also noted at this point that concentrations of metals mentioned hereinafter are understood herein as being determined by ICP (all metals) or by titration (in the cases of Ti and Fe—ferrous and ferric).

As is indicated in the above-mentioned International application, U.S. Pat. No. 3,760,058 in the name Langmesser et al (assigned to Farbenfabriken Bayer AK) discloses a part of the above-described process.

The reference herein to the Bayer U.S. patent is not to be taken as an indication that the disclosure in the patent is part of the common general knowledge of persons skilled in the field of the invention.

The applicant has carried out further research work on the above-described process since the priority date of 17 Oct. 2003 of the International application and has identified a number of features that are not disclosed in the above-mentioned International application that are important, separately and in combination, in order to operate the process effectively and that form the basis of the present invention.

The present invention is based on features of the leach step (a) of leaching titaniferous material that are described hereinafter that were identified in the further research work.

Other features of the above-described process that were identified in the further research work are described in the specification lodged with the Australian provisional application 2005901749 in the name of the applicant and the disclosure in this specification is incorporated herein by cross-reference.

Preferably leach step (a) is a multiple stage leach step involving (i) a first stage of leaching a solid titaniferous material with a leach solution containing sulfuric acid and forming a process solution that includes an acidic solution of titanyl sulfate (TiOSO₄) and iron sulfate (FeSO₄), (ii) separating the process solution and a residual solid phase, (iii) leaching the residual solid phase from the first stage in a subsequent stage with a leach solution and forming a process solution that includes an acidic solution of titanyl sulfate and iron sulfate, (iv) separating the process solution and a residual solid phase, and (v) supplying the separated process solution to the first leach stage and/or mixing the separated process solution with the process solution from first leach stage. The individual stages of the multiple stage leach step may be carried out in multiple tanks or in a single tank.

Preferably step (a) includes carrying out leaching at controlled acidity, with a maximum acid concentration of 450 g/L in process solution discharged from the leach step.

Preferably the process includes supplying the separated process solution from step (d) and/or the separated liquid phase from step (g) to leach step (a).

In the above-mentioned further research work, the applicant has found that it is preferable that the leach step (a) be controlled to maximise residence time of solids in contact with the leach solution in the leach tank or the leach tanks and minimise residence time of liquors (ie the leach solution and/or the process solution) in the leach step.

Specifically, the applicant has found that it is preferable to move liquors through “hot” areas of the leach tank or the leach tanks as quickly as possible to avoid premature precipitation of titanyl sulfate.

The applicant has found that it is possible to control solids and liquors residence time by confining agitation (if used at all) within the leach tank or the leach tanks to be no more than gentle agitation. Gentle agitation reduces carryover of solids in tank overflow and thereby increases the residence time of solids.

The term “gentle” agitation of a leach tank is understood herein to mean agitation that allows solid-liquid separation to occur in the tank.

The applicant has also found that it is possible to control residence time by creating gentle upward flow of liquors in the leach tank or the leach tanks, whereby solids fall back under the influence of gravity or mechanical screening, thereby maximising residence time of solids in contact with leach solution and minimising residence time of liquors.

In addition to the above, the applicant has also found that it is preferable to produce process solutions containing high concentrations of titanium, such as concentrations of at least 40 g/L, preferably at least 50 g/L, and more preferably at least 70 g/L, in the leach step in order to minimise capital cost of the leach step.

The applicant has also found that the leaching step may be carried out with one leach tank in each stage, a plurality of leach tanks in each stage, or a combination of a single tank in one or more stages and a plurality of tanks in one or more stages. Where a stage comprises a plurality of tanks, there may be recycling of process solution within the tank(s).

The process of the present invention includes the following typical reactions.

### Leaching:

FeTiO₃+2H₂SO₄→FeSO₄+TiOSO₄+2H₂O

Ferric reduction: Fe₂(SO₄)₃+Fe^{o}→3FeSO₄

Ferrous sulfate crystallisation: FeSO₄+7H₂O→FeSO₄.7H₂O

Titanyl sulfate precipitation: TiOSO₄+2H₂O→TiOSO₄.2H₂O

Hydrolysis: TiOSO₄+2H₂O→TiO(OH)₂+H₂SO₄

Calcination: TiO(OH)₂→TiO₂+H₂O

The applicant has carried out experimental work on a laboratory scale and a pilot plant scale in relation to the above-described process.

The improved sulfate process of the present invention is now described further by way of example only with reference to the accompanying flow sheet.

The flowsheet includes the following main steps:

(a) leach;

(b) ferrous sulfate crystallisation;

(c) titanyl sulfate crystallisation;

(d) titanium dissolution;

(e) hydrolysis for pigment;

(f) rutile seed preparation;

(g) bleaching,

(h) calcination; and

(i) finishing.

Each of the above steps is described hereinafter in turn.

(a) Leach Step

The leach step includes two leach stages 1 and 2 carried out in separate tanks 3, 5.

Each leach stage is carried out in a single tank 3, 5 as indicated in the flowsheet or in multiple tanks (not shown) arranged in series.

The leach stages 1 and 2 may be a fully counter-current or may be co-current with fresh return filtrate and/or wash filtrates being added to both leach stages.

The chemistry of the leach step is:

FeTiO₃+2H₂SO₄→TiOSO₄+FeSO₄+2H₂O

Leaching is carried out at a controlled acidity of 450 g/L (±25 g/L) H₂SO₄ in each stage. Under these conditions about 80% leaching takes place in two leach stages, each of about 12 hours residence time.

The leaching temperature is typically 110° C. in each stage, which is less than the solution boiling point. The temperature is not controlled, but sufficient heat is generated during leaching to keep the slurry at about 110° C. Some top-up steam may be required for start up.

One option is to use scrap iron addition into the leach tanks 3, 5. This has been found to increase leach kinetics significantly. Some reductant is required to convert ferric sulfate to ferrous sulfate to allow all iron to exit in the form of FeSO₄ crystals.

The leach tanks 3, 5 are simple stirred tanks, each of which operates with an overflow to a thickener 7. Fibre-reinforced plastic (FRP) is suitable for wetted parts. Other suitable materials are acid bricks and tiles.

The leach tanks 3, 5 are operated with gentle stirring so that the residence time of solids in the tanks is longer than the residence time of liquor in the tanks.

The leach slurries discharged from the tanks 3, 5 are thickened in conventional thickeners 7. The settling rate is high for partly reacted ilmenite. Flocculation is possible. Underflow densities exceeding 60% are feasible, but lower solids loadings may be required to ensure pumpability.

The solids loading in the leach step is controlled to give a process solution of about 40 g/L Ti, 90-100 g/L Fe and 400-450 g/L acid that leaves the leach step as overflow from the downstream thickener 7. These are the preferred concentrations of Fe and Ti without having ferrous sulfate or titanyl sulfate crystallise out prematurely.

Ilmenite is added dry to the first leach tank 3.

To control the acidity to 450 g/L (±25 g/L) return filtrate from a titanyl sulfate crystallisation step 19 discussed hereinafter is supplied via line 9 to the tanks 3, 5 and/or additional sulfuric acid is metered into the tanks 3, 5. In situations where there are multiple tanks 3, 5 in each stage, most of the acid is added to the first two tanks 3, 5 in each stage. In practice, the acidity in later tanks may be uncontrolled.

Thickener underflow from the thickener 7 of the first leach stage is pumped to the leach tank 5 of the second leach stage.

Some recycled acid at about 350 g/L (±25 g/L) H₂SO₄, which is a filtrate from a filtration step 37 downstream of a hydrolysis step 25 described hereinafter, is also pumped via line 11 to the leach tank 5.

Titanyl sulfate crystallisation filtrate produced in a filtration step 31 described hereinafter is also added via line 11 to the second tank 5 to maintain the acidity at 450 g/L (±25 g/L).

Leaching is about 50-60% in the first stage rising to about 80% overall by the end of the second stage. Higher extractions are feasible with further leaching.

The second stage leach slurry that is discharged from the leach tank 5 is thickened in the thickener 7.

In a full counter-current operation the second stage overflow from the thickener 7 is pumped to the first stage leach tank 3. In a co-current circuit the solids loading is higher in both stages so that the target of 40 g/L Ti is reached in the final process solution.

Second stage leach residue is filtered via filter 13 and the resilient filter cake is suspended in recycled water. Limestone and lime are added to raise the pH to 7-8, and the slurry is pumped to tailings 15.

The process solution contained in the (unwashed) filter cake that is supplied to tailings 15 represents the major outlet for a number of minor elements, such as Cr and Zn.

Low acidity in the leach stages can cause the premature hydrolysis and precipitation of TiO(OH)₂. Typically this becomes significant below about 425 g/L H₂SO₄. Above 450 g/L H₂SO₄ it is likewise possible to prematurely crystallise out titanyl sulfate dihydrate, TiOSO₄.2H₂O.

(b) Ferrous Sulfate Crystallisation Step

Almost all iron in solution eventually leaves the circuit as green crystals of ferrous sulfate, FeSO₄.7H₂O, in a ferrous sulfate crystallization step 17.

Significant water is also rejected from the process in the ferrous sulfate, also known as ‘copperas’. This allows recovery and recycling of medium strength acid from the hydrolysis step, leading to a much lower overall acid consumption per tonne of TiO₂ product.

In the ferrous sulfate crystallization step 17, hot process solution discharged as the overflow from the downstream thickener 7 of the leach step is firstly cooled to about 60° C. in a heat exchanger (not shown) by heat exchange with process solution that has been discharged from a downstream crystallization tank (not shown).

The cooled pregnant process solution is then evaporatively cooled to about 20° C. This causes ferrous sulfate to crystallise out in the tank. The cooled process solution at this stage contains about 40 g/L Fe and 55 g/L Ti. The Ti concentration rises due to the lower volume of the cooled process solution.

Removal of water by evaporation may be included to give a further water credit, allowing recovery of more weak acid.

The ferrous sulfate crystals may be separated from the process solution by a conventional centrifuge (not shown) or by a belt filter (not shown).

Some washing may be possible, but the high solubility of the crystals means that washing should be minimised if possible.

The ferrous sulfate may be sold directly or converted to another saleable product.

Although 40 g/L Fe remains in solution, the iron is recirculated and eventually returns to the ferrous sulfate crystallization step 17. The ferrous sulfate crystals therefore are essentially the only point of exit for iron from the circuit.

Mn, Al and Mg are minor elements which exit the circuit primarily with the ferrous sulfate crystals.

Finally, the cold process solution that is discharged from the ferrous sulfate crystallization step 17 is partially reheated by cross flow heat exchanging against incoming hot process solution supplied to the step 17.

(c) Titanyl Sulfate Precipitation Step

Fresh 98% sulfuric acid that is required for leaching ilmenite is not added in the leach stages of the leach step. Instead, the acid is added in a titanyl sulfate precipitation step, generally identified by the numeral 19.

The acid causes titanium to precipitate out of the process solution as titanyl sulfate dihydrate, TiOSO₄.2H₂O, and form a slurry in accordance with the following reaction:

TiOSO₄+2H₂O→TiOSO₄.2H₂O

The actual mechanism of precipitation is not clear.

The preferred operating temperature in the titanyl sulfate precipitation step is 110° C. Precipitation is very slow at less than 90° C.

Precipitation is self seeding—the kinetics of crystallisation are accelerated by the presence of the product crystals.

The solids have a long needle-like shape (typically 1 μm width by 100 μm long). The needle-like morphology causes significant rheology problems in the titanyl sulfate precipitation step. Quite low solids loadings can result in thick porridge-like slurries which resist pumping and agitation.

In one particular embodiment the precipitation tank (or one or more than one of the precipitation tanks in situations where there are multiple tanks) has an upstanding draft tube that has an upper inlet and a lower outlet and the draft tube is located to divide the tank into an outer chamber and a central cylindrical chamber. The assembly also includes an impeller to help circulation of the slurry. The slurry flows through the draft tube and the outer chamber in the tank.

To keep the slurry in a fluid state a recycle of filtrate may be used.

The solids in the slurry that is discharged from the precipitation tank or tanks are separated from the slurry by filtration. Filtration may be by a belt filter 21 shown in the flowsheet. However, maintaining the temperature of the filtrate probably requires pressure filtration.

Some washing of the solids in the filter cake on the filter 21 by recycled acid from the hydrolysis step described hereinafter may be carried out as this improves purity of the high strength Ti solution going to hydrolysis.

The acid washed TiOSO₄.2H₂O filter cake is a stable solid product and offers a convenient breakpoint in the flowsheet. The filter cake may be stock-piled as indicated by the numeral 27. Temporary storage of the acid washed crystals offers useful buffer capacity, and makes the process more robust.

The filtrate contains about 700 g/L H₂SO₄ (roughly 50% w/v) plus 10 g/L Ti and 40 g/L Fe. Some is recycled to the titanyl sulfate precipitation stage tank 19. The rest is sent to the leach stages via line 9, where it is used to control the acidity to 450 g/L H₂SO₄ in the leach slurry.

Thickening before filtration is not used due to the needle-like solids, which do not compact readily under gravity.

(d) Titanium Dissolution

The acid washed filter cake from the stockpile 27 is re-pulped in a 30% H₂SO₄ solution in a re-pulping step 29 and is then is pumped to a filter 31. The resultant slurry has an acid concentration of the order of 400 g/L.

The filter cake on the filter 31 may be washed with hydrolysis filtrate to remove remaining entrained leach liquor.

Finally, a carefully controlled water wash is used to displace all the remaining acid in the filter cake on the filter 31. Reducing the acid concentration to below 200 g/L destabilises the solids, leading to ultimate dissolution of the solids. Cake squeezing and/or air blowing is then used to control the moisture content of the cake. About 5 g/L Ti reports to the wash filtrate, which is recycled via line 11 to the leach stages.

As described above, these washing steps may be applied to the initial filtration step to eliminate the need to re-pulp and re-filter the solids. However, in doing so the ability to store an intermediate filter cake is lost and the process is less robust.

The water washed filter cake discharged from the filter 31 is added to a stirred tank 35. Over a period of about 2 hours at 60° C. the cake dissolves into a high strength Ti solution. Lower temperatures can also be used, although the dissolution time may be longer than 2 hours.

The target concentration is 150 g/L Ti (=250 g/L “TiO₂”). Concentrations exceeding 200 g/L Ti have been produced in laboratory and pilot plant work. However, 150 g/L or above is suitable for conventional pigment hydrolysis.

The dissolution process preferably requires less than 100 g/L acid in the solution contained within the filter cake to ensure that the process goes to completion. If most or all acid is washed out the free acid content of the high strength solution is quite low. In pigment industry terms the acid to titania (A/T) ratio is usually about 1.3 (the theoretical minimum is 1.225 at zero acidity).

The product high strength solution produced in the stirred tank 35 is filtered through a filter cartridge (not shown) to remove siliceous and other fine particulate matter.

Unlike normal metal sulfates, the TiOSO₄.2H₂O in the filter cake does not immediately dissolve in water. Also its solubility in >20% H₂SO₄ is quite low. This suggests the dissolution process is not strictly dissolution. The remarkable solubility of Ti at low acidity (>200 g/L Ti) compared to 20% H₂SO₄ (˜5 g/L Ti) favours this view.

(e) Hydrolysis Step

The filtered high strength Ti process solution is suitable for all conventional pigment hydrolysis processes.

It also may be used for continuous or batch precipitation of coarse high purity TiO(OH)₂.

The pigment hydrolysis processes are typically batch processes due to critical need to control particle size.

Feed solution to the pigment hydrolysis step is pretreated to generate about 2 g/L of Ti³⁺ in the solution by conventional means. The Ti³⁺ protects against oxidation of any iron to Fe³⁺, which coprecipitates with the Ti and imparts undesirable colour to the pigment.

The process solution is then adjusted with acid to an A/T ratio suitable for pigmentary hydrolysis, using either concentrated H₂SO₄ or preferably the hydrolysis filtrate. The A/T ratio is a key process parameter. A/T ratio is:

[Free acid+bound acid in TiSO₄]÷[TiO₂]

All parameters are expressed in g/L.

In practice the [Free acid+bound acid in TiOSO₄] concentration is measured by a simple titration to pH 7 with sodium hydroxide solution, and the [TiO₂] g/L is Ti g/L÷0.6.

In one example of commercial practice, the hydrolysis is carried out by preheating a heel of water, typically 10-20% of the volume of feed solution, to about 96° C.

The process solution is also preheated to about 96° C. and then is pumped across to the batch hydrolysis tank over a fixed time period.

The hydrolysis tank 25 is equipped with steam heating and a gate type rake stirrer, which operates at low rpm. Preferably the steam heating is indirect so that the filtrate is not diluted by condensate.

The initial few seconds of pumping cause the precipitation of very fine TiO(OH)₂ particles, which cause a milky aspect for about 30 seconds, then appear to redissolve. In practice the fine particles are colloidal nuclei which control the size of both the resulting precipitate and the crystal size in the calciner discharge. Control of this step is therefore key to preparing good pigment.

After all process solution is pumped across or dropped in from a header tank, the slurry temperature is carefully heated to the boiling point (typically at 1° C./minute).

The slurry is then boiled for about 5 hours, by which time the Ti remaining in solution has been lowered to about 5 g/L.

The slurry discharged from the hydrolysis tank 25 is filtered and washed with water on a belt filter 37 and produces a TiO(OH)₂ filter cake and a filtrate.

There are no special requirements for filtration as the particle size has already been established. A range of filters are used across the industry. The particles naturally floc together and the filtration rate is fast enough that vacuum filtration may be used. The filter cake contains about 55% w/w of water.

The filtrate from the filter 37 contains 350-450 g/L H₂SO₄. This is returned via line 11 to the leach step for slurrying ilmenite and/or first stage thickener underflow. The acid units thereby are used to leach ilmenite. Recycling this acid is limited by the overall circuit water balance, and is favoured by higher acidity (ie. a lower volume equates to the higher acidity). Any excess is sent to a clean gypsum plant 49.

(f) Rutile Seed Preparation Step

In one example of commercial practice, rutile seed is made in a rutile seed preparation step 41 by reacting some TiO(OH)₂ filter cake discharged from the belt filter 37 with commercial 50% NaOH solution, for several hours at the boiling point (about 117° C.):

2NaOH+TiO(OH)₂→Na₂TiO₃+2H₂O

4NaOH+TiOSO₄→Na₂TiO₃+Na₂SO₄+2H₂O

The TiO(OH)₂ filter cake contains about 4% S in the form of absorbed basic titanium sulfates. The resulting sodium titanate is filtered and washed well to completely remove sulfate. The washed cake is then mixed with a carefully controlled amount of commercial 35% HCl to produce a solution of TiCl₄;

Na₂TiO₃+6HCl→TiCl₄+2NaCl+3H₂O

The solution is then boiled to generate ultrafine TiO(OH)₂ particles:

TiCl₄+3H₂O→TiO(OH)₂+4HCl

The resulting slurry contains about 100 g/L TiO₂ in the rutile form. It may be used directly if the downstream flowsheet can tolerate Cl ions or it can be decantation washed to remove the NaCl.

(g) Bleaching Step

The Ti(OH)₂ filter cake that is discharged from the belt filter 37 and is not used to make rutile seed is re-pulped with clean H₂SO₄ solution in a bleaching step 43. Al or Zn dust is added to reductively leach out chromophores such as Fe, Cr, Mn and V, which otherwise would reduce the whiteness of the final pigment.

The bleach step typically takes place at 80° C. The rutile seed slurry is added at this point in a carefully controlled amount (e.g. 4.0±0.1% w/w). The bleached slurry is filtered and washed.

The TiO(OH)₂ filter cake, which has a sulfur content of about 2%, is mixed with a number of additives. These may be added as water solutions, or solids. The additives may include 0.2% K₂O as K₂SO₄, 0.6% ZnO as ZnSO₄ and 0.3% P₂O₅ as H₃PO₄.

The additives control development of the rutile crystals during calcination, such that the crystal size is 0.27±0.03 μm, rutilisation is 98.5±0.5%, the crystals have a lenticular shape and are not sintered together.

In addition to the above-described steps, the process flowsheet also includes the steps of: calcination 45, finishing 47, and, if required, clean gypsum production 49. These steps are conventional steps.

Many modifications may be made to the process flowsheet described above without departing from the spirit and scope of the present invention.

By way of example, as an alternative to pigment production, the process is able to produce coarse high purity titania that can be used, for example, as a feedstock for electrochemical reduction to produce titanium metal and alloys. Hydrolysis may be carried out continuously in this option. Several simple stirred tanks may be used in a cascade arrangement. Hydrolysis may be carried out at boiling point using steam heating, preferably indirect. Seeding is carried out by recycling thickener underflow to the first tank. This allows the slurry residence time to be 8-12 hours and generates a particle size d₅₀ of about 20 microns. Thickening gives a dense slurry of about 30% solids by weight, which may be vacuum filtered and washed. Bleaching may be carried out per the pigment process, if required. No rutile or chemical seeds are used. Calcination only requires a temperature of the order of 900° C. for about 1 hour.

The present invention is described further with reference to the following examples.

Within these examples where ‘free H₂SO₄’ has been referred to, this has been determined by titration of an oxalate buffered solution sample with sodium hydroxide solution to an end point of pH 7.

### EXAMPLE 1

This example describes a first stage of batch leaching with water washing of the leach residue.

A solution (300 L) containing 3.0 g/L Ti, 11.2 g/L Fe²⁺, 3.0 g/L Fe³⁺, and 716 g/L free H₂SO₄ was heated in a stirred, baffled vessel. Once the liquor had reached 110° C., 79.6 kg of ilmenite concentrate containing 25.9% FeO, 19.3% Fe₂O₃ and 50.4% TiO₂, which had previously been ground in a ball mill to 80% less than 38 μm, was introduced into the reaction vessel. Six 10 mm diameter mild steel rods were suspended in the reactor such that about 200 mm of the rods extended below the solution level. The mixture was allowed to react at 110° C. for 3 hours, after which the temperature was allowed to fall steadily to 80° C. over the next 3 hours. The resulting slurry was filtered through a recessed plate filter and the cake was washed with fresh water. The filtrate contained 47 g/L Ti, 55 g/L Fe²⁺, 17 g/L Fe³⁺, 618 g/L free H₂SO₄, and had a specific gravity of 1.637 g/cm³. The weight of the washed filter cake was 39 kg with a moisture content of 16.9%. The washed filter cake was assayed on a dry weight basis and was found to contain 15.3% FeO, 24.4% Fe₂O₃ and 48.7% TiO₂.

Based on the weights and compositions of the ilmenites and cake, 60.6% of the TiO₂ in the ilmenite dissolved during the leach process.

### EXAMPLE 2

This example describes a second stage of leaching using the washed first stage leach residue.

A solution (273 L) containing 3.6 g/L Ti, 6.1 g/L Fe²⁺, 2.4 g/L Fe³⁺, and 711 g/L free H₂SO₄ was heated in a stirred, baffled vessel. Once the liquor had reached 110° C., 130 kg of wet cake prepared as described in Example 1, having a moisture content of 18.6% and containing 17.0% FeO, 22.7% Fe₂O₃ and 49.4% TiO₂, was introduced into the reaction vessel. Six 10 mm diameter mild steel rods were suspended in the reactor such that about 200 mm of the rods extended below the solution level. The mixture was allowed to react at 110° C. for 3 hours, after which the temperature was allowed to fall steadily to 80° C. over the next 3 hours. The resulting slurry was filtered through a recessed plate filter and the cake was washed with fresh water. The filtrate contained 46 g/L Ti, 38 g/L Fe²⁺, 20 g/L Fe³⁺, 513 g/L free H₂SO₄, and had a specific gravity of 1.553 g/cm³. The weight of the washed filter cake was 86 kg with a moisture content of 26.2%. The washed filter cake was assayed on a dry weight basis and was found to contain 13.3% FeO, 22.7% Fe₂O₃ and 49.7% TiO₂.

Based on the weights and compositions of the feed and product and cakes, 39.7% of the TiO₂ in the feed cake dissolved during the leach process.

### EXAMPLE 3

This example describes a leach step operating with a relatively long solids residence time compared to the solution residence time.

Ilmenite concentrate (60 g per hour) which had been ground in a ball mill to 80% less than 38 μm, and a solution (50 mL per minute) containing 3.0 g/L of TiO₂, 8.3 g/L of Fe²⁺, 2.5 g/L of Fe³⁺, and 714 g/L free H₂SO₄ were continuously fed to a specially designed 4.8 L continuous glass reactor, which allowed mixing of the solids and the solution in the base of the reactor, but prevented the solids from exiting the reactor with the solution as it overflowed. This system, with an agitation rate of 100 rpm, enabled a long solids retention time and a short solution retention time. The chemical composition of the ilmenite concentrate was 17.0% FeO, 22.7% Fe₂O₃ and 49.4% TiO₂. The ilmenite concentrate was fed to the reactor in batches once per hour. The temperature was maintained at 110° C. Iron (4 g) in the form of thin rod, was added to the reactor initially and each hour thereafter. The process was operated for 37 hours, although analysis of the solution exiting the reactor indicated that steady state operation was achieved after about 10 hours. After steady state was achieved the solution exiting the reactor had an average composition of 8.2 g/L of TiO₂, 16.2 g/L of Fe²⁺, 4.7 g/L of Fe³⁺, 704 g/L free H₂SO₄. An average of 52.1% of the titanium in the ilmenite concentrate dissolved during the steady state period. Solid titanyl sulphate did not form in the reaction slurry.

### EXAMPLE 4

This example describes the reduction and removal of Fe³⁺ from the solution produced as described in Examples 1-3.

A 5 L baffled glass reactor fitted with an 80 mm Rushton 6 turbine agitator was filled with 4 L of a solution containing 13.2 g/L Fe³⁺, 38.5 g/L Fe²⁺, 505 g/L free H₂SO₄ and 40 g/L Ti. The agitation rate was set at 500 rpm. The reactor was temperature controlled to 50° C. On reaching this temperature a pump was used to recirculate the solution at 100 mL/min from the glass vessel, and through a 4 L fibre reinforced plastic (FRP) vessel containing a single 150 mm×150 mm×150 mm compressed bale of commercial detinned scrap steel. The solution was introduced to the bottom of the FRP vessel and flowed up through the scrap and overflowed via gravity back into the glass reactor. The bale of scrap was height adjusted to be fully submerged below the level of the solution in the FRP vessel. After recirculating the solution for 45 min it was found that all Fe³⁺ had been consumed. After 60 minutes the pump was turned off and the bale of scrap removed, whereupon it was found the solution contained 0 g/L Fe³⁺, 93 g/L Fe²⁺ and 8.5 g/L Ti³⁺.

### EXAMPLE 5

This example shows that ferrous sulfate may be batch precipitated from an ilmenite leach solution.

An ilmenite leach solution containing 0.1 g/L Fe³⁺, 98.2 g/L Fe²⁺, 48 g/L Ti and 399 g/L free H₂SO₄, prepared in the manner described in Example 4, was placed in a beaker and cooled overnight. Green ferrous sulfate heptahydrate crystals with composition 18.5% Fe, 10.5% S, 0.23% Ti and 0.15% Mn were then recovered from the resulting slurry. The filtrate was assayed and found to contain <1 g/L Fe³⁺, 30.2 g/L Fe²⁺ and 539 g/L free H₂SO₄.

### EXAMPLE 6

This example shows that titanyl sulfate dihydrate, TiOSO₄.2H₂O, crystals may be batch precipitated from an ilmenite leach solution prepared in the manner of Examples 1-3 by the addition of sulfuric acid and that a high strength solution suitable for pigment manufacturing may be generated by dissolution of the crystals.

Sulfuric acid (98%, 450 g) was mixed with an ilmenite leach solution (1500 mL) containing 440 g/L free H₂SO₄, 35.4 g/L Fe²⁺, 7.4 g/L Fe³⁺ and 29 g/L Ti in a glass reactor equipped with baffles and a Teflon agitator. The resulting solution was heated to 110° C. and titanyl sulfate crystals (4 g) were added as seed material. The mixture was stirred at this temperature for a total of 6 hours, during which a thick precipitate formed. The slurry was filtered and the cake was washed with water to give a wet filter cake (238 g). The filtrate contained 16 g/L Ti, 638 g/L H₂SO₄ and 48 g/L Fe, of which 6.6 g/L was as Fe³⁺. The filter cake dissolved after 3 hours to produce a titanyl sulfate solution containing 160 g/L Ti and 8.3 g/L Fe.

### EXAMPLE 7

This example describes the continuous precipitation of titanyl sulfate dihydrate, TiOSO₄.2H₂O, crystals, followed by vacuum filtration.

Ilmenite leach solution (603.6 L) prepared as described in Examples 1-3, containing 524.7 g/L free H₂SO₄, 14.5 g/L Fe²⁺, 4.3 g/L Fe³⁺ and 41.2 g/L Ti was mixed in an agitated fibreglass reactor with titanyl sulfate filtrate (1043.2 L) containing 637.5 g/L free H₂SO₄, 44.7 g/L Fe²⁺, 12.8 g/L Fe³⁺ and 6.1 g/L Ti. Sulfuric acid (98%, 88.3 L) was then added along with titanyl sulfate filter cake (10 kg, 14% w/w solids) and the temperature was raised to 110° C. The reactor was 1.35 m diameter, with 1.3 m solution depth and contained a draft tube to improve mixing and the uniformity of mixing inside the reactor with minimal power input. The draft tube was 0.9 m internal diameter, 0.87 m high and raised 0.25 m from the bottom of the reactor. The reactor was fitted with an axial turbine with diameter of 0.6 m and raised 0.5 m from the floor of the reactor. The turbine operated at 250 rpm. The reactor was allowed to stir at temperature for 12 hours and a sample was taken and filtered. The titanium concentration in the liquor had dropped from an initial combined level of 17.3 g/L to 9.0 g/L. The feed and product pumps were started and set to flowrates of 4.6 L/min to allow for a 4.9 hour residence time with a constant combined feed solution containing 17.5 g/L Ti and 660 g/L H₂SO₄. The precipitator was run continuously this way for 10 hours producing 2742 L of titanyl sulfate slurry. Regular samples were taken from the reactor and filtered and analysed. These filtrate samples gave average concentrations of 7.5 g/L Ti and 611.8 g/L H₂SO₄. The precipitated titanyl sulfate dihydrate was separated from the slurry using a belt filter, giving approximately 780 kg of filter cake with solids loading 14% w/w.

### EXAMPLE 8

This example demonstrates that titanyl sulfate dihydrate, TiOSO₄.2H₂O, crystals prepared in the manner of Examples 6 and 7 may be dissolved in water to produce a high strength titanyl sulfate solution.

Titanyl sulfate dihydrate filter cake (19 kg) produced using the process described in Example 7 was re-pulped into a pumpable slurry using a solution containing 400 g/L H₂SO₄ (4 L) mixed with re-pulp filtrate (36 L) containing 485 g/L free H₂SO₄, 6.7 g/L Fe²⁺, 9.6 g/L Fe³⁺ and 5.9 g/L Ti. The slurry was allowed to stir for 15 minutes and then was filtered using a plate and frame filter. A sample of the filtrate from this filtering step was analysed and was found to contain 510 g/L free H₂SO₄, 8.9 g/L Fe²⁺, 10.7 g/L Fe³⁺ and 7.4 g/L Ti. Water (50 L) was pumped through the filter to wash the solids. A sample of the filtrate from the washing step was analysed and found to contain 137 g/L free H₂SO₄, 2.2 g/L Fe²⁺, 3 g/L Fe³⁺ and 3.3 g/L Ti. The washed solids were collected and were allowed to dissolve overnight. The resulting titanyl sulfate solution was filtered to remove fine, undissolved solids, which were predominately silica.

The solution was found by assay to contain 467 g/L total H₂SO₄, 1.7 g/L Fe²⁺, 6.5 g/L Fe³⁺ and 194 g/L Ti.

### EXAMPLE 9

This example describes the conversion of a titanyl sulfate dihydrate slurry directly into a high concentration titanium solution suitable for production of pigment, without an intermediate re-pulp step.

Titanyl sulfate slurry (108 L) produced from the reactor described in Example 7 was filtered using a membrane pressure filter, instead of the belt filter described in Example 7. Recycled filter acid (45 L) containing 338.4 g/L free H₂SO₄, 10.1 g/L Fe²⁺, 2.3 g/L Fe³⁺ and 10.1 g/L Ti was mixed with recycled wash water (50 L) containing 93.2 g/L free H₂SO₄, 3.4 g/L Fe²⁺, 0.7 g/L Fe³⁺ and 3.4 g/L Ti and with 450 g/L sulfuric acid (10 L). This mixed acid stream was then passed through the membrane pressure filter to wash the filtered solids. The solids were then further washed with water (50 L) and squeezed at a pressure of 4 bar for 5 minutes. Compressed air was then blown through the washed cake for 5 minutes. The filter cake was then removed from the filter and transferred to a container where it dissolved over a period of several hours to give a titanyl sulfate solution containing 218 g/L Ti and 333.5 g/L free H₂SO₄.

### EXAMPLE 10

This example describes the precipitation of pigment capable titanium hydroxide from high strength titanyl sulfate solution, using conventional practice.

High strength titanyl sulfate solution (2.5 L) prepared as described in Example 8 was filtered to remove residual solids, then zinc dust (13 g) was added with stirring to remove ferric ions and to generate trivalent titanium ions. The solution on analysis was found to contain approximately 3.0 g/L of Ti³⁺. Concentrated sulfuric acid was added to give an A/T ratio of 1.70±0.05. The solution was then concentrated by evaporation under reduced pressure to give a viscosity of 22-25 cp at 60° C. and 330±10 g/L of TiO₂ in the final concentrated liquor.

Hydrolysis was carried out based on the Blumenfeld method. A water heel (0.5 L) was heated to 98±10° C. in a glass reactor equipped with external electrical heating, a temperature controller, thermocouple and a rake type stirrer. The pretreated A/T controlled liquor (2.0 L) was separately heated to 98±1° C. before being added to the water heel at a controlled rate such that all the liquor was added to the heel within 17±1 minutes. The temperature profile was then controlled to precipitate TiO₂ at a relative rate of 0.7 to 1.0% per minute by ramping the heating rate to give a temperature rise 0.5° C. per min up to the boiling point. Agitation and heating were then stopped for 30 minutes. After this ‘stop time’ agitation and heating were reapplied to continue precipitation at the rate of 0.7 to 1.0% per minute relative to the initial TiO₂ concentration. After an overall reaction time of 5 hours the batch was quenched with 2 L of water. Once the solution was cooled to less than 60° C. the solution was vacuum filtered using a Buchner funnel and the precipitate washed with water (6 L) at 60° C. The cake was allowed to dry by filtration to achieve 30% solids as TiO₂. In total 608 g of titanium hydroxide was produced, corresponding to a yield of 96%.

### EXAMPLE 11

This example describes the production of rutile seed slurry, which may be used to assist with the rutilisation process during calcination.

Titanium hydroxide filter cake (750 g, loss on ignition 68%) prepared as described in Example 10 was placed in a reaction vessel equipped with agitation and external heating. To the paste, pellets of sodium hydroxide (495 g) were slowly added over 30 minutes. A lid was then placed over the vessel. The temperature was set to 126° C. and was maintained at this level with agitation for a further 60 minutes. At the end of this time the reaction was quenched to 60° C. by adding sufficient water to lower the solids loading to 140 g/L equivalent TiO₂ (resulting in a total slurry volume of 1713 mL). The slurry was then filtered using a Buchner funnel, and the precipitate washed with water at 60° C. until the wash filtrate contained approximately 1 g/L equivalent Na₂O, measured using a calibrated conductivity meter.

The washed filter cake was then transferred to a reflux vessel equipped with an agitator and reslurried to 255 g/L equivalent TiO₂ (giving a slurry volume of 941 mL). The slurry pH was adjusted to 2.8 using concentrated HCl (90 mL, 33% w/v). A 1 g sample was removed to test for cake quality. To the remaining slurry sufficient concentrated HCl (298 mL, 33% w/v) was added to give an HCl:TiO₂ ratio of 0.41, and the temperature was raised to 60° C. The temperature was then increased to the boiling point at a controlled rate of 1° C. per minute, and maintained at the boiling point for 90 minutes, after which the slurry was quenched with water to a volume of 2400 mL, giving a solids loading equivalent to 97 g/L TiO₂. A small sample was neutralized with NaOH, filtered, washed and dried was found by XRD to contain 100% rutile form TiO(OH)₂.

### EXAMPLE 12

This example describes conventional reductive acid leaching of precipitated titanium hydroxide to remove chromophores.

The filtered cake (63.5 g) from Example 10 was slurried in water (0.07 L) in a glass vessel equipped with a laboratory agitator. Concentrated H₂SO₄ (98%, 9.0 g) was added to the stirred slurry after which coarse rutile nuclei (8.6 mL; prepared as described in Example 11) was added to the slurry to achieve 4% added rutile TiO₂. The seeded slurry was made up to 0.1 L with water and heated to 75° C. Once at temperature zinc dust was added (0.5 g) and the slurry was maintained at temperature for 2 hours. The slurry was then cooled to 60° C. and vacuum filtered in a Buchner funnel. The final filtrate was analysed for Ti³⁺ concentration to confirm sufficient Ti³⁺ was present (>0.4 g/L Ti³⁺ preferred (as TiO₂)). The cake was then washed with water at 60° C. (three times the volume of precipitate cake). The final cake (60 g) was allowed to dry under vacuum filtration to approximately 30% solids.

### EXAMPLE 13

This example describes calcination of titanium hydroxide to produce a substantially rutilised TiO₂ calcine with crystal size suitable for pigment production.

The cake paste (300 g) prepared as described in Example 12 was mechanically mixed in the presence of H₃PO₄ (98% solution), Al₂(SO₄)₃, K₂SO₄ to give 0.15% P₂O₅, 0.18% Al₂O₃ and 0.28% K₂O as calculated after calcination, until a homogenous mixture is obtained. The paste was the extruded through a 5 mm die onto glass surface, covered then dried in a 75° C. laboratory oven for 12 hours. The solids were then transferred to an electrically heated muffle furnace and the temperature was ramped to 920° C. for 3 hours. The calcined solids were removed from the furnace and allowed to cool to ambient temperature, and the rutilisation measured by XRD was found to be 97.3%.

### EXAMPLE 14

Cooled TiO₂ solids (800 g) prepared as described in Example 13 were then processed through a laboratory hammer mill and sieved to achieve a particle size of less than 90 microns. The milled particles were then slurried in room temperature water to give a solids loading of 400 g/L (as TiO₂) with the aid of organic dispersant (1,1,1-tris-hydroxymethyl propane). The dispersed slurry was pH adjusted to 10-11 by the addition of 10% w/v NaOH solution. The slurry was then passed through a hydraulic bead mill (bead size 0.8-1.0 mm, zirconia stabilized) in recirculation mode until a mean particle size of 0.27 μm was achieved. The slurry was then passed through a 325 μm sieve and the oversize was discarded.

The sieved slurry (2 L) was then transferred to a 3 L beaker and heated to 50° C. using an external electric heating mantle. Four solutions (20% w/v H₂SO₄, 10% w/v NaOH, 100 g/L (as ZrO₂) ZrCl₂.8H₂O and NaAlO₂ (caustic stabilized solution containing 17-18% w/w Al₂O₃)) were filled into separate 50 ml burettes and their volumes noted. The reagents were added at temperature such that a final concentration of Al₂O₃ (3.5% of TiO₂ content) and ZrO₂ (0.88% of TiO₂ content) was achieved. The slurry was then filtered and washed with water at 60° C. to achieve soluble salts in the cake as less than 0.1% as Na₂SO₄, and dried for about 3 hours under vacuum. The cake paste was then mechanically mixed in the presence of organic dispersant to achieve 0.2% carbon (w/w) on the TiO₂. The paste was then extruded through a 5 mm die onto glass surface, which was covered and dried in a 75° C. laboratory oven for 6 hours to achieve less than 1.0% H₂O. The solids were then lightly hammer milled and the resulting solids passed through a laboratory air microniser which was operated at 6 bar (dried compressed air) for injection and grinding. The micronised product mean particle size was milled to between 0.30 and 0.33 μm as determined by optical density measurements.

### EXAMPLE 15

This example shows the ability to continuously hydrolyse high strength titanium solution to produce coarse TiO(OH)₂ which may be settled and filtered readily.

A continuous pilot plant comprising of 2×5 L fibre-reinforced plastic (FRP) vessels, equipped with axial turbines and heaters, and an FRP thickener of diameter 30 cm and height 90 cm, equipped with rakes and a rake drive motor, was assembled. The FRP vessels and thickener were arranged in series with cascading overflow pipes between them to allow slurry to flow from vessel to vessel by gravity. An acidic slurry of titanium hydroxide (4 kg) prepared as described in Example 10 was placed in the first vessel as seed, and a solution of 300 g/L of H₂SO₄ in water (5 L) was placed in the second vessel to assist the initial start up phase. The vessels were heated to a temperature of 100° C. with stirring. On reaching temperature a solution of titanium sulfate prepared as described in Example 8, and containing Ti 130 g/L, Ti³⁺ 5 g/L, total acid 330 g/L and Fe 10 g/L, was pumped to the first vessel at a rate of 7.5 mL/min. Water was also added at a rate of 6 mL/min to correct for evaporation. On filling of the thickener, a portion of the underflow corresponding to 5 mL/min and 20% w/w solids loading was thereafter continuously pumped to the first vessel to act as seed. In total the hydrolysis pilot plant was operated continuously for 75 hours. On reaching steady state under these process conditions it was found that the vessels and process streams equilibrated to the following compositions.

| | Ti g/L | Ti³⁺ g/L | Fe g/L |
|---|---|---|---|
| Feed solution | 130 | 5 | 10 |
| Vessel 1 | 70 | 1.4 | 11 |
| Vessel 2 | 14 | 0.9 | 9 |

Combined thickener underflow flowrate was 7 mL min (of which 5 mL/min was recycled as described). Equilibrated thickener overflow flowrate was 9 mL/min. The solids loading in the thickener underflow reached 30% w/w by the end of the run. The particle size of the thickener underflow solids was determined using a Malvern 2000 laser sizer and was found to be d₅₀ 7.8 μm.

1. A sulfate process for producing titania from a titaniferous material (such as ilmenite) of the type which includes the steps of:
(a) leaching the solid titaniferous material with a leach solution containing sulfuric acid and forming a process solution that includes an acidic solution of titanyl sulfate (TiOSO₄) and iron sulfate (FeSO₄);
(b) separating the process solution and a residual solid phase from the leach step (a);
(c) precipitating titanyl sulfate from the process solution from step (b);
(d) separating the precipitated titanyl sulfate from the process solution;
(e) treating the precipitated titanyl sulfate and producing a solution containing titanyl sulfate;
(f) hydrolysing the titanyl sulfate in the solution and forming a solid phase containing hydrated titanium oxides and a liquid phase;
(g) separating the solid phase containing hydrated titanium oxides and the liquid phase;
(h) calcining the solid phase from step (g) and forming titania; and
(i) removing iron sulfate from the process solution from step (b) and/or the depleted process solution from step (d).

2. The process defined in claim 1 further includes supplying one of the separated process solution from step (d) and the separated liquid phase from step (g) to the leach step (a).

3. The process defined in claim 1 wherein leach step (a) is a multiple stage leaching step with each stage being carried out in one of a single leach tank and multiple leach tanks that includes (i) a first stage of leaching the solid titaniferous material with a leach solution containing sulfuric acid and forming a process solution that includes an acidic solution of titanyl sulfate (TiOSO₄) and iron sulfate (FeSO₄), (ii) separating the process solution and a residual solid phase, (iii) leaching the residual solid phase from the first stage in a subsequent stage with a leach solution and forming a process solution that includes an acidic solution of titanyl sulfate and iron sulfate, (iv) separating the process solution and a residual solid phase, and (v) supplying the separated process solution to one of the first leach stage and the process solution from the first leach stage.

4. The process defined in claim 1 includes controlling leach step (a) to maximise residence time of solids in contact with the leach solution in a leach step and to minimise residence time of liquors in the leach step.

5. The process defined in claim 4 includes controlling leach step (a) by moving liquors through the leach tank as quickly as possible to avoid premature precipitation of titanyl sulfate.

6. The process defined in claim 4 includes controlling leach step (a) by confining agitation within a leach tank to be no more than gentle agitation, thereby minimizing carryover of solids in tank overflow and maximising residence time of solids in the leach tank or leach tanks.

7. The process defined in claim 4 includes controlling leach step (a) by creating gentle upward flow of liquors in the leach tank, whereby solids fall back under the influence of gravity or mechanical screening, thereby maximising residence time of solids in the leach tank or leach tanks.

8. The process defined in claim 1 includes controlling leach step (a) to produce the process solution with a concentration of titanium ions of at least 40 g/L.

9. The process defined in claim 9 includes controlling leach step (a) to produce the process solution with a concentration of titanium ions at least 50 g/L.

10. The process defined in claim 9 includes controlling leach step (a) to produce the process solution with a concentration of titanium ions of at least 70 g/L.
